(19) United States
(12) Patent Application Publication
(10) Pub. No.: US 2009/0235128 A1
(43) Pub. Date: Sep. 17, 2009

(54) Data detecting apparatus based on channel information and method thereof

(75) Inventors: Heeseok Eun, Seoul (KR); Jun Jin Kong, Yongin-si (KR); Jae Hong Kim, Seoul (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/230,502

(22) Filed: Aug. 29, 2008

(30) Foreign Application Priority Data
Mar. 12, 2008 (KR) 10-2008-0022963

(51) Int. Cl. G06F 11/10; G06F 12/02; G06F 11/34

(52) U.S. Cl. 714/704; 711/100; 714/763; 714/E11.189; 714/E11.034; 711/E12.002

(57) ABSTRACT

An apparatus and a method for detecting data stored in a memory cell based on channel information of the memory cell are provided. The data detecting apparatus may include a voltage comparison unit that compares a plurality of soft decision reference voltages between neighboring hard decision reference voltages with a threshold voltage of a memory cell to determine a region including the threshold voltage, and a data detection unit that detects data stored in the memory cell based on channel information of the memory cell according to the region. The data detecting apparatus may further include a reference voltage determination unit that determines the plurality of soft decision reference voltages based on the channel information of the memory cell.

### PRIORITY STATEMENT

This application claims priority under 35 U.S.C. §119 to Korean Patent Application No. 10-2008-0022963, filed on Mar. 12, 2008, in the Korean Intellectual Property Office (KIPO), the entire contents of which are incorporated herein by reference.

### BACKGROUND

1. Field

Example embodiments relate to a data detecting apparatus stored in a memory cell, for example, to an apparatus that determines a soft decision reference voltage or a soft decision value for detecting data based on channel information in a memory cell.

2. Description of Related Art

A single-level cell (SLC) memory device may store one data bit in a single memory cell. The SLC memory may be referred to as a single-bit cell (SBC) memory. The SLC memory may store and read one data bit at a voltage level included in two distributions that may be divided by a threshold voltage level programmed in a memory cell. The programmed threshold voltage may have a distribution within a certain range due to a fine electric characteristic difference between the SLC memories. For example, when a voltage level read from the memory cell is greater than 0.5V and less than 1.5V, it may be determined that the data stored in the memory cell has a logic value of “1”. When the voltage level read from the memory cell is greater than 2.5V and less than 3.5V, it may be determined that the data stored in the memory cell has a logic value of “0”. The data stored in the memory cell may be classified depending on the difference between cell currents and/or cell voltages during the reading operations.

Meanwhile, a multi-level cell (MLC) memory device that may store data of two or more bits in a single memory cell has been proposed in response to a need for higher integration of memory. The MLC memory device may be also referred to as a multi-bit cell (MBC) memory. However, as the number of bits stored in the single memory cell increases, reliability may deteriorate and a read-failure rate may increase. To store “N” bits in a single memory cell, 2^{N} voltage level distributions may be required. However, since the voltage window for a memory device may be limited, the difference in threshold voltage between adjacent bits may decrease as “N” increases, causing the read-failure rate to increase. For this reason, it may be difficult to improve storage density using the MLC memory device according to conventional art.

### SUMMARY

Example embodiments may provide an apparatus to determine a soft decision reference voltage value in a memory cell based on channel information of the memory cell.

Also, example embodiments may provide an apparatus to determine a soft decision value for detecting data stored in a memory cell based on channel information of the memory cell.

According to example embodiments, a data detecting apparatus may include, a voltage comparison unit that compares a plurality of soft decision reference voltages between neighboring hard decision reference voltages with a threshold voltage of a memory cell to determine a region including the threshold voltage, and a data detection unit that detects data stored in the memory cell based on channel information of the memory cell according to the region.

In example embodiments, the data detecting apparatus may further include a reference voltage determination unit that determines the plurality of soft decision reference voltages based on the channel information of the memory cell.

In example embodiments, the data detecting apparatus may also include a soft decision value allocation unit that allocates a soft decision value based on the channel information of the memory cell, according to the region, wherein the data detection unit detects data stored in the memory cell based on the allocated soft decision value.

In example embodiments, the data detecting apparatus may further include a pilot data storage unit that stores pilot data in a predetermined bit pattern in the memory cell, and a channel information estimation unit, wherein the data detection unit detects the stored pilot data, and the channel information estimation unit estimates channel information of the memory cell based on the detected pilot data.

According to example embodiments, a data detecting method may include comparing a plurality of soft decision reference voltages between neighboring hard decision reference voltages with a threshold voltage of a memory cell to determine a region including the threshold voltage, and detecting data stored in the memory cell based on channel information of the memory cell according to the region.

In example embodiments, the data detecting method may further include determining the plurality of soft decision reference voltages based on the channel information of the memory cell.

In example embodiments, the data detecting method may also further include allocating a soft decision value based on the channel information of the memory cell, according to the region, wherein the detecting detects data stored in the memory cell based on the allocated soft decision value.

In example embodiments, the data detecting method may further include storing pilot data in a predetermined bit pattern in the memory cell, and estimating channel information of the memory cell, wherein the detecting detects the stored pilot data, and the estimating estimates the channel information of the memory cell based on the detected pilot data.

According to example embodiments, it may be possible to determine a soft decision reference voltage in a memory cell based on channel information of the memory cell.

According to example embodiments, it may be possible to determine a soft decision value for detecting data stored in a memory cell based on channel information of the memory cell.

### BRIEF DESCRIPTION OF THE DRAWINGS

The above and/or other aspects and advantages will become more apparent and more readily appreciated from the following detailed description of example embodiments taken in conjunction with the accompanying drawings, in which:

FIG. 1 a block diagram illustrating a configuration of a data detecting apparatus determining a soft decision reference voltage based on channel information of a memory cell according to example embodiments;

FIG. 2 is a diagram illustrating operations of a soft decision reference voltage determination unit determining a soft decision reference voltage based on channel information of a memory cell according to example embodiments;

FIG. 3 is a block diagram illustrating a configuration of a data detecting apparatus allocating a soft decision value based on channel information of a memory cell according to example embodiments;

FIG. 4 is a diagram illustrating operations of a soft decision value allocation unit allocating a soft decision value based on channel information of a memory cell according to example embodiments; and

FIG. 5 is a block diagram illustrating a configuration of a data detecting apparatus determining a soft decision reference value and allocating a soft decision value based on channel information of a memory cell.

### DETAILED DESCRIPTION OF EXAMPLE EMBODIMENTS

Example embodiments will now be described more fully with reference to the accompanying drawings. Embodiments, however, may be embodied in many different forms and should not be construed as being limited to example embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” or “coupled to” to another component, it may be directly on, connected to, or coupled to the other component or intervening components may be present. In contrast, when a component is referred to as being “directly on,” “directly connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

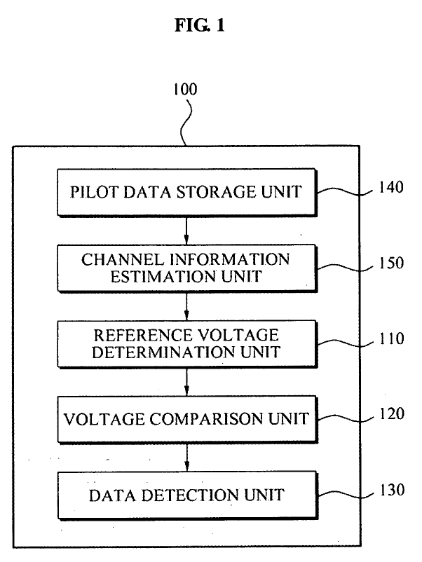

FIG. 1 a block diagram illustrating a configuration of a data detecting apparatus 100 determining a soft decision reference voltage based on channel information of a memory cell according to example embodiments. Hereinafter, operations of the data detecting apparatus 100 according to example embodiments will be described in detail by referring to FIG. 1. The data detecting apparatus 100 according to example embodiments includes a reference voltage determination unit 110, a voltage comparison unit 120, a data detection unit 130, a pilot data storage unit 140, and a channel information estimation unit 150.

The reference voltage determination unit 110 may determine a soft decision reference voltage between neighboring hard decision reference voltages based on channel information of a memory cell.

A threshold voltage in the memory cell may be determined according to data stored in the memory cell. A range of the threshold voltage in the memory cell may be divided into a plurality of regions by a reference voltage. When one-bit data is stored in a memory cell, a range of a threshold voltage in a memory cell may be divided into two regions by a single reference voltage. As an example, when a memory cell stores N-bit data, a range of a threshold voltage in the memory cell may be divided into 2^{N} regions by 2^{N}-1 reference voltages.

According to example embodiments, the reference voltage determination unit 110 may determine a soft decision reference voltage between the hard decision reference voltages, as well as the hard decision reference voltages to distinguish the 2^{N} number of regions. A hard decision region between a first hard decision reference voltage and a second hard decision reference voltage may be repeatedly divided into a plurality of soft decision regions by a soft decision reference voltage.

The voltage comparison unit 120 may determine a region including the threshold voltage by comparing the threshold voltage in the memory cell with the plurality of soft decision reference voltages.

A range of the threshold voltage in the memory cell may be divided into a plurality of hard decision regions by the hard decision reference voltages. Each hard decision region may be divided into a plurality of soft decision regions by a plurality of soft decision reference voltages. The voltage comparison unit 120 may determine whether the threshold voltage of the memory cell is included in one of the soft decision regions.

The data detecting apparatus 100 may also determine which soft decision region the threshold voltage in the memory cell is included in among the hard decision regions between the hard decision reference voltages.

The data detection unit 130 may detect data stored in the memory cell according to a region including the threshold voltage. The data detecting apparatus 100 may detect the data stored in the memory cell depending on whether the threshold voltage in the memory cell is included in one of the hard decision regions. The data detecting apparatus 100 may also determine the data stored in the memory cell depending on which region, from among the plurality of regions, the threshold voltage in the memory cell is included.

According to example embodiments, the data stored in the memory cell may be error-correction coded according to a predetermined error-correction coding scheme. The data detection unit 130 may detect data according to the predetermined error-correction coding scheme. According to example embodiments, the data stored in the memory cell may be coded according to a Convolutional coding scheme, a Bose-Chadhuri-Hocquenghem (BCH) coding scheme, a Time Compression Multiplexing (TCM) coding scheme, a Block Coded Modulation (BCM) coding scheme, a Reed-Solomon coding scheme, and/or a Turbo coding scheme. The data detection unit 130 may detect the data stored in the memory cell by decoding the data stored in the memory cell based on an error-correction decoding scheme corresponding to the predetermined error-correction coding scheme.

As a number of data bits stored in a memory cell increases, a range of each region may become narrower, and an error rate may increase during the course of determining whether a threshold voltage is included in a region.

The data detection unit 130 may determine whether the threshold voltage in the memory cell is included in one of the soft decision regions from among hard decision regions based on the soft decision reference voltage. The data detection unit 130 may more accurately detect the data stored in the memory cell by additionally considering information indicating in which soft decision region the threshold voltage is included from among hard decision regions, as well as information with respect to the hard decision region including the threshold voltage.

The data detecting apparatus 100 may more accurately detect the data stored in the memory cell based on the additional information about which soft decision region from among the hard decision regions the threshold voltage in the memory cell is included.

According to example embodiments, the reference voltage determination unit 110 may determine a soft decision reference voltage so that intervals between the plurality of soft decision reference voltages or intervals between the hard decision reference voltages and the soft decision reference voltage are irregular.

According to example embodiments, the reference voltage determination unit 110 may determine the soft decision reference voltage based on channel information of the memory cell. According to example embodiments, the channel information may include information about an operation temperature of the memory cell storing data, noise information of the memory cell, and information about an error rate in the memory cell storing the data. According to example embodiments, the channel information may also include information about a total number of times the data is stored in the memory cell, a total number of times the data is deleted from the memory cell, and a length of time after the data is stored in the memory cell.

The information about the error rate in the memory cell storing the data may depend on the operation temperature of the memory cell. Generally, as the operation temperature of the memory cell increases, an error rate in the data stored in the memory may also increase. Even when an operation temperature of a memory cell may not be higher than a threshold temperature at which data is stored in the memory cell, the operation temperature of the memory cell may still be higher than the threshold voltage at which data is detected from the memory cell. In this instance, an error rate in the data stored in the memory cell may have increased in comparison to the error rate at the threshold voltage.

According to example embodiments, the reference voltage determination unit 110 may determine the soft decision reference voltage based on an operation temperature of the memory cell at which data is stored in the memory cell or an operation temperature in the memory cell at which data is detected in the memory cell. The reference voltage determination unit 110 may determine the soft decision reference voltage by considering changes of the operation temperature. Therefore, a soft decision reference voltage at which data is detected from the memory cell may not correspond to a soft decision reference voltage at which data is stored in the memory cell.

According to example embodiments, the reference voltage determination unit 110 may determine the soft decision reference voltage based on noise information of the memory cell. The information of the memory cell may include information about an average of a noise occurring in a memory cell, power information of a noise occurring in a memory cell, and/or information about a model of a noise occurring in a memory cell. The information about the model of the noise occurring in the memory cell may include information whether a noise occurring in the memory cell is a normal distribution, a log normal distribution, and/or the Rayleigh distribution. The reference voltage determination unit 110 may determine the soft decision reference voltage based on information about a type of a noise, the average of the noise, and/or the power information. An error may occur when a comparison result of the threshold voltage in the memory cell with the hard decision reference voltage in the memory cell does not correspond to the data stored in the memory cell. That is, an error may occur in data when a threshold voltage is included in another region for an arbitrary reason, the threshold voltage being included in a region between the first hard decision reference voltage and the second hard decision reference voltage when storing the threshold voltage. The threshold voltage at which data is detected may not be identical to the threshold voltage at which data is stored. If a change of a threshold voltage is included in the region between the hard decision reference voltages, an error may not occur. However, if the change of the threshold voltage exceeds the region between the hard decision reference voltages, an error may occur in data.

Even when an error occurs in data stored in a memory cell, generally, a threshold voltage in a memory cell may not exceed greatly a hard decision reference voltage. For example, when a difference between a threshold voltage in a memory cell and neighboring hard decision reference voltage is large, there may be a low probability of error occurrence in data stored in a memory cell. However, when a difference between a threshold voltage in a memory cell and neighboring hard decision reference voltage is small, there may be a large probability of error occurrence in data stored in a memory cell.

According to example embodiments, a soft decision reference voltage may be determined based on at least one of a number of times data is stored in a memory cell, a number of times data is deleted from a memory cell, and/or a length of time after data is stored in a memory cell. As the number of times data is stored in the memory cell increases and the number of times data is deleted from the memory cell increases, performance of data storage in the memory cell may deteriorate. Therefore, the reference voltage determination unit 110 may determine the soft decision reference voltage in the memory cell based on a total number of times data is stored in the memory cell and a total number of times data is deleted from the memory cell.

Depending on the length of time after data is stored in the memory cell, the threshold voltage in the memory cell may greatly change. The soft decision reference voltage at which data is detected from the memory cell may not be identical to the soft decision reference voltage at which data was stored in the memory cell. Therefore, the reference voltage determination unit 110 may determine the threshold voltage in the memory cell according to the length of time elapsed since the data was stored in the memory cell.

According to example embodiments, the pilot data storage unit 140 may store pilot data in a predetermined bit pattern in a memory cell. Also, the data detection unit 130 may detect pilot data stored in the memory cell, and the channel information estimation unit 150 may estimate channel information of the memory cell based on the detected data.

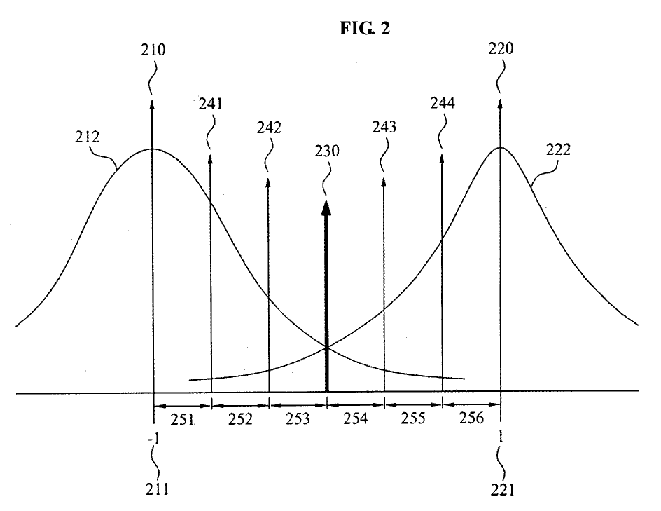

FIG. 2 is a diagram illustrating operations of a reference voltage determination unit determining a soft decision reference voltage based on channel information of a memory cell according to example embodiments. Hereinafter, a method for determining a soft decision reference voltage will be described in detail by referring to FIG. 2.

Depending on data 211 and 221 to be stored in a memory cell, a range of a threshold voltage in the memory cell may be determined. Threshold voltages 210 and 220 in the memory cell may change over time. Voltage distributions 212 and 222 may represent a range of the threshold voltages 210 and 220, respectively. When a change of the threshold voltage is not significant, data may be detected by comparing the threshold voltage in the memory cell with a hard decision reference voltage 230.

According to example embodiments, a hard decision region between a plurality of hard decision reference voltages may be divided into a plurality of soft decision regions by using a plurality of soft decision reference voltages 241, 242, 243, and 244.

A data detecting apparatus may detect data stored in a memory cell based on which soft decision region the threshold voltage is included.

As a change of the threshold voltage in the memory cell increases, a value of the threshold voltage may become closer to a hard decision reference voltage. When a difference between the threshold voltage and the hard decision reference voltage is not significant, there may be a larger probability of an error rate in the data stored in the memory cell. For example, even when the data detecting apparatus has determined a hard decision region including the threshold voltage, it may not be determined that the threshold voltage has been included in a corresponding hard decision region or that a value of the threshold voltage has changed, although the threshold voltage is included in a neighboring hard decision region.

According to example embodiments, the reference voltage determination unit 110 of FIG. 1 may determine a soft decision reference voltage according to an error rate in the memory cell. A soft decision region may change when the soft decision reference voltage changes. The soft decision region including the threshold voltage may change. A soft decision value may change according to the soft decision region. The data detection unit 130 may detect data stored in the memory cell based on the soft decision value. Consequently, when the soft decision reference voltage is changed, a detection result of the data detection unit 130 may be changed.

Generally, depending on a channel state in a memory cell, a threshold voltage changes in the memory cell. That is, an amount of the threshold voltage in the memory cell being changed or frequencies of the threshold voltage in the memory cell being changed may be determined according to the channel state of the memory cell. According to example embodiments, the reference voltage determination unit 110 may determine the soft decision reference voltage based on the channel information of the memory cell since an error rate in data may be determined according to the channel state of the memory cell.

According to example embodiments, intervals between a plurality of soft decision reference voltages 241, 242, 243, and 244 may not be regular. A range of each soft decision region 251, 252, 253, 254, 255, and 256 may be individually determined.

According to example embodiments, the channel information may include an error rate according to a threshold voltage value, and the reference voltage determination unit 110 may determine intervals between the soft decision reference voltages based on the information about the error rate according to the threshold voltage value. The reference voltage determination unit 110 may determine the soft decision reference voltage so that an interval between soft decision reference voltages is wide within a range with a low error rate, and determine the soft decision reference voltage so that an interval between the soft decision reference voltages is narrower within a range with a large error rate.

Generally, by closely dividing the range with the large error rate, a range including the threshold voltage in the memory cell may be generally determined. Data stored in the memory cell may be more accurately detected since more information may be obtained with respect to a region. The region may not be clear as to whether an error occurs or not.

According to example embodiments, a soft decision reference voltage may be determined so that an interval between soft decision reference voltages is narrow at a range with a low error rate, and may be determined so that an interval between soft decision reference voltages is wide at a range with a low error rate. When a threshold voltage is included in a range with a large error rate, information that may be obtained from a location of the threshold voltage in the memory cell may be inaccurate. Accurate information may be obtained from the threshold voltage in the memory cell by closely dividing a range with a low error rate. When an error occurs in the data stored in the memory cell, the error may be corrected according to an error-correction coding scheme.

According to example embodiments, channel information of a memory cell may be generated by storing pilot data in the memory cell and detecting the stored pilot data.

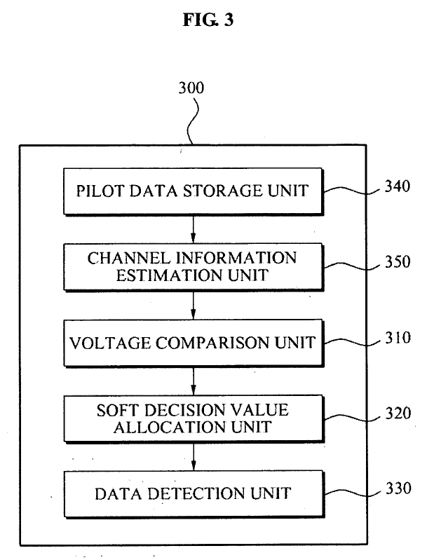

FIG. 3 is a block diagram illustrating a configuration of a data detecting apparatus 300 allocating a soft decision value based on channel information of a memory cell according to example embodiments. Hereinafter, operations of the data detecting apparatus 300 will be described in detail by referring to FIG. 3. The data detecting apparatus 300 according to example embodiments includes a voltage comparison unit 310, a soft decision value allocation unit 320, a data detection unit 330, a pilot data storage unit 340, and a channel information estimation unit 350.

The voltage comparison unit 310 may compare a threshold voltage in a memory cell with a soft decision reference voltage which may be determined in advance. The soft decision reference voltage in the memory cell may be located between a range of the threshold voltage in the memory cell. The voltage comparison unit 310 may compare the soft decision reference voltage with the threshold voltage to determine which region, if any, from among a plurality of soft decision regions the threshold voltage is included.

The soft decision value allocation unit 320 may allocate a soft decision value based on channel information of the memory cell according to the region including the threshold voltage. According to example embodiments, the soft decision value being allocated in the soft decision value allocation unit 320 may be a Log Likelihood Ratio (LLR) with respect to a region including the threshold voltage.

According to example embodiments, the channel information may include information about an operation temperature of the memory cell storing data, noise information of the memory cell, and/or information about an error rate in the memory cell storing the data. The channel information may also include at least one of a total number of times data is stored in the memory cell, a total number of times the data is deleted from the memory cell, and a length of time after the data is stored in the memory cell.

An operation temperature of the memory cell at which data is stored in the memory cell may be different from an operation temperature in the memory cell at which data is detected in the memory cell. As an operation temperature of the memory cell increases, an error rate in data stored in the memory cell may also increase. According to example embodiments, the channel information of the memory cell includes noise information of the memory cell, and the soft decision value allocation unit 320 may allocate a soft decision value based on the noise information of the memory cell. According to example embodiments, when a probability density function of noise occurring in a memory cell is a normal distribution, a soft decision value may be allocated according to a value of a linear function having a threshold voltage to be an input. According to example embodiments, when a probability density function of noise occurring in a memory cell is a log normal distribution or the Rayleigh distribution, a soft decision value may be allocated according to a value of a non-linear function having a threshold voltage to be an input.

According to example embodiments, the soft decision value allocation unit 320 may allocate a soft decision value based on a number of times data is recoded in a memory cell or based on a number of times data stored in the memory cell is deleted. Generally, when data is repeatedly recorded and deleted in a memory cell, a capability of the memory cell storing data may deteriorate. The soft decision value allocation unit 320 may allocate a soft decision value by considering the deterioration of the memory cell due to the repeated data storing.

According to example embodiments, the soft decision value allocation unit 320 may allocate a soft decision value based on a length of time after data is stored in a memory cell. A threshold voltage in a memory cell may change as time elapses after the data is stored in the memory cell. Generally, the threshold voltage may decrease over time. Therefore, the soft decision value allocation unit 320 may allocate a soft decision value based on a length of time from when data is stored in a memory cell to when data is detected.

According to example embodiments, the channel information of the memory cell may include information about an error rate according to the threshold voltage in the memory cell, and the soft decision value allocation unit 320 may allocate the soft decision value according to the information about the error rate.

When a difference between the threshold voltage in the memory cell and a hard decision reference voltage in the memory cell is not relatively large, an error rate may be large in the data stored in the memory cell. Conversely, when a difference between a threshold voltage in the memory cell and a hard decision reference voltage in the memory cell is relatively large, an error rate may be low in the data stored in the memory cell.

According to example embodiments, the soft decision value allocation unit 320 may allocate a soft decision value having a small absolute value with respect to a region with a large error rate, and allocate a soft decision value having a large absolute value with respect to a region with a small error rate, from among a range of threshold voltage values. In this instance, depending on the range of threshold voltage values, a soft decision value to be allocated may always be greater than “0.” Alternatively, depending on the range of the threshold voltage values, a soft decision value to be allocated may also be smaller than “0.”

The data detection unit 330 may detect the data stored in the memory cell based on the soft decision value allocated by the soft decision value allocation unit 320. According to example embodiments, the data stored in the memory cell may be error-correction coded according to a predetermined error-correction coding scheme, and the data detection unit 330 may detect the data stored in the memory cell according the predetermined error-correction coding scheme.

According to example embodiments, the data stored in the memory cell may be coded according to a Convolutional coding scheme, a BCH coding scheme, a TCM coding scheme, a BCM coding scheme, a Reed-Solomon coding scheme, and/or a Turbo coding scheme. The data detection unit 130 may detect the data stored in the memory cell by decoding the data stored in the memory cell based on an error-correction decoding scheme corresponding to the predetermined error-correction coding scheme.

According to example embodiments, the pilot data storage unit 340 may store pilot data in a predetermined bit pattern in a memory cell, and the data detection unit 330 may detect the pilot data stored in the memory.

The channel estimation unit 350 may estimate channel information of the memory cell based on the detected data.

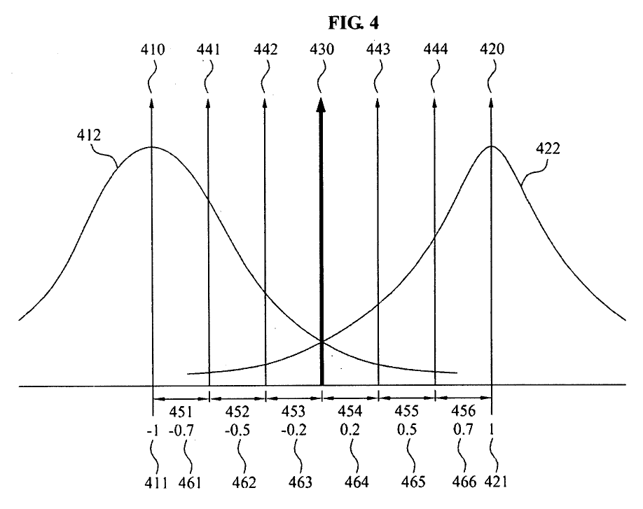

FIG. 4 is a diagram illustrating operations of a soft decision value allocation unit that allocates a soft decision value based on channel information of a memory cell according to example embodiments. Hereinafter, a method for allocating a soft decision value according to example embodiments will be described in detail by referring to FIG. 4.

Depending on data 411 and 421 to be stored in a memory cell, values of threshold voltages 410 and 420 may be determined. Voltage distributions 412 and 422 may represent a range of the threshold voltages 410 and 420, respectively. The threshold voltages 410 and 420 may change over time. Therefore, a threshold voltage at which data is stored in the memory cell may not be identical to a threshold voltage at which data is detected in the memory cell.

When threshold voltages 410 and 420 are larger than a hard decision reference voltage 430, it may be determined that “1” is stored in the memory cell. However, when the threshold voltages 410 and 420 are smaller than the hard decision reference voltage 430, it may be determined that “−1” is stored in the memory cell.

According to example embodiments, the data detecting apparatus 300 may detect data by closely dividing a range of a threshold voltage in a memory cell. Regions of the hard decision reference voltage may be divided into a plurality of soft decision regions 451, 452, 453, 454, 455, and 456 utilizing a plurality of soft decision reference voltages 441, 442, 443, and 444. It may be determined in which region of the soft decision regions 451, 452, 453, 454, 455, and 456 the threshold voltage in the memory cell is included. The data detecting apparatus 300 may allocate soft decision values 461, 462, 463, 464, 465, and 466 according to soft decision regions 451, 452, 453, 454, 455, and 456 including the threshold voltage in the memory cell, thereby detecting the data in the memory cell according to the allocated soft decision values.

According to example embodiments, a soft decision value which will be allocated to each soft decision region may be determined by a linear function having a center value of soft decision regions to be an input. In this instance, an average of two soft decision reference voltages distinguishing each soft decision region may be defined to be the center value of the soft decision regions. The linear function may calculate a soft decision value in proportion to the center value of each of the soft decision regions. Each soft decision value may be located on an identical straight line. When each soft decision value is allocated utilizing a linear function, a soft decision value may be calculated utilizing a simple function based on a center value of a soft decision region.

According to example embodiments, a soft decision value allocated to each soft decision region may be determined by a non-linear function having a center value of a soft decision region to be an input. A straight line including all calculated soft decision values may not exist.

According to example embodiments described in FIG. 3, soft decision values −0.7, −0.5, −0.2, 0.2, 0.5, and 0.7 are allocated according to each soft decision region.

It may be assumed that each soft decision region is equally divided. A difference between each of soft decision values allocated to each soft decision region is 0.2, 0.3, 0.2, 0.3, 0.3, and 0.2, and the differences are not equal to each other. When differences between soft decision values are not equal to each other even though soft decision regions are equally divided, a straight line including each soft decision value may not exist. Therefore, a soft decision value may be defined to be non-linear.

Depending on a noise occurring in a memory cell, a threshold voltage in the memory cell may change. Depending on a pattern of the noise occurring in the memory cell, a pattern of the threshold voltage in the memory cell may change. Depending on the pattern of the threshold voltage in the memory cell, a soft decision value allocated to each soft decision region may be determined. Since the data detecting apparatus 300 detects data based on the soft decision value, an error rate in data may be minimized when the soft decision value is determined based on noise information of the memory cell.

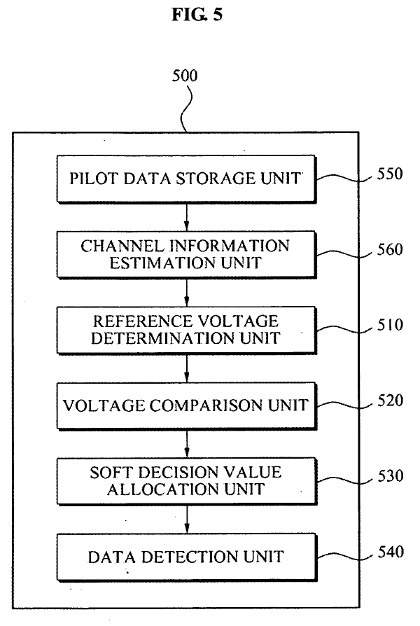

FIG. 5 is a block diagram illustrating a configuration of a data detecting apparatus 500 determining a soft decision reference voltage and allocating a soft decision value, based on channel information of a memory cell. Hereinafter, operations of the data detecting apparatus 500 will be described in detail by referring to FIG. 5. The data detecting apparatus 500 according to example embodiments includes a reference voltage determination unit 510, voltage comparison unit 520, a soft decision value allocation unit 530, a data detection unit 540, a pilot data storage unit 550, and a channel information estimation unit 560. The pilot data storage unit 550 and the channel information estimation unit 560 may be similar to those described previously, and thus will not be discussed in detail.

The reference voltage determination unit 510 may determine a plurality of soft decision reference voltages between neighboring hard decision reference voltages based on channel information of a memory cell. According to example embodiments, the channel information may include information about an error rate according to a threshold voltage, and the reference voltage determination unit 510 may determine the plurality of soft decision reference voltages so that the intervals between the plurality of soft decision reference voltages are close with respect to a region with a larger error rate from among a range of the threshold voltages.

The voltage comparison unit 520 may determine a region including the threshold voltage by comparing the threshold voltage in the memory call with a soft reference decision voltage determined in the reference voltage determination unit 510.

The soft decision value allocation unit 530 may allocate a soft decision value based on the channel information of the memory cell according to the region including the threshold voltage.

The data detection unit 540 may detect data stored in the memory cell based on the soft decision value allocated by the soft decision value allocation unit 530. According to example embodiments, the data stored in the memory cell may be error-correction coded according to a predetermined error-correction coding scheme, and the data detection unit 540 may detect the data stored in the memory cell according to the error-correction coding scheme. According to example embodiments, the data stored in the memory cell may be coded according to a Convolutional coding scheme, a BCH coding scheme, a TCM coding scheme, a BCM coding scheme, a Reed-Solomon coding scheme, and a Turbo coding scheme. The data detection unit 540 may detect the data stored in the memory cell by decoding the data stored in the memory cell based on an error-correction decoding scheme corresponding to the predetermined error-correction coding scheme.

According to example embodiments, the channel information includes information about an error rate, and the soft decision value allocation unit 530 may allocate a soft decision value according to the information about the error rate. An error rate occurring in the data stored in the memory cell may be reduced when the soft decision value is allocated according to the information about the error rate.

According to example embodiments, the soft decision value allocation unit 530 may allocate a soft decision value which has a small absolute value to a region with a relatively large error rate from among a range of the threshold voltages. Generally, when data of “1” or “−1” is stored in a memory cell, a soft decision value may be allocated to a region with a large error rate so that an absolute value of the allocated soft decision value is approximately “0,” and a soft decision value may be allocated to a region with a small error rate so that an absolute value of the allocated soft decision value is approximately “1.”

According to example embodiments, the soft decision value allocation unit 530 may allocate a soft decision value which has a small value to a region with a large error rate from among a range of the threshold voltages, and allocate a soft decision value which has a large value to a region with a small error rate from among a range of the threshold voltages. The allocated soft decision value may be a value determined utilizing a non-linear function.

While example embodiments have been particularly shown and described, it will be understood by those of ordinary skill in the art that various changes in form and details may be made therein without departing from the spirit and scope of example embodiments as defined by the following claims.

What is claimed is:

1. A data detecting apparatus, comprising:
a voltage comparison unit that compares a plurality of soft decision reference voltages between neighboring hard decision reference voltages with a threshold voltage of a memory cell to determine a region including the threshold voltage; and
a data detection unit that detects data stored in the memory cell based on channel information of the memory cell according to the region.

2. The apparatus of claim 1, further comprising:
a reference voltage determination unit that determines the plurality of soft decision reference voltages based on the channel information of the memory cell.

3. The apparatus of claim 2, wherein the channel information includes at least one of an operation temperature of the memory cell, noise information of the memory cell, information about an error rate in the memory cell, a total number of times the data is stored in the memory cell, a total number of times the data is deleted from the memory cell, and a length of time after the data is stored in the memory cell.

4. The apparatus of claim 2, further comprising:
a soft decision value allocation unit that allocates a soft decision value based on the channel information of the memory cell, according to the region,
wherein the data detection unit detects data stored in the memory cell based on the allocated soft decision value.

5. The apparatus of claim 2, wherein the reference voltage determination unit determines the soft decision reference voltage so that intervals between the plurality of soft decision reference voltages are irregular.

6. The apparatus of claim 2, wherein,
the channel information includes information about an error rate according to the threshold voltage, and
the reference voltage determination unit determines the intervals between the plurality of soft decision reference voltages based on the error rate.

7. The apparatus of claim 6, wherein the reference voltage determination unit determines the plurality of soft decision reference voltages so that the intervals between the plurality of soft decision reference voltages are close with respect to a region with a larger error rate from among a range of the threshold voltages.

8. The apparatus of claim 1, wherein the data is error-correction coded according to a predetermined error-correction coding scheme, and the data detection unit detects the data according to the error-correction coding scheme.

9. The apparatus of claim 1, further comprising:
a soft decision value allocation unit that allocates a soft decision value based on channel information of the memory cell according to the region,
wherein the data detection unit detects data stored in the memory cell based on the allocated soft decision value.

10. The apparatus of claim 9, wherein the channel information includes information about an error rate according to the threshold voltage, and the soft decision value allocation unit allocates the soft decision value according to the information about the error rate.

11. The apparatus of claim 10, wherein the soft decision value allocation unit allocates a small soft decision value to a region with a large error rate, and allocates a large soft decision value to a region with a small error rate, from among a range of the threshold voltages.

12. The apparatus of claim 9, wherein the soft decision value corresponds to a log likelihood ratio.

13. The apparatus of claim 1, further comprising:
a pilot data storage unit that stores pilot data in a predetermined bit pattern in the memory cell; and
a channel information estimation unit,
wherein the data detection unit detects the stored pilot data, and the channel information estimation unit estimates channel information of the memory cell based on the detected pilot data.

14. A data detecting method, comprising:
comparing a plurality of soft decision reference voltages between neighboring hard decision reference voltages with a threshold voltage of a memory cell to determine a region including the threshold voltage; and
detecting data stored in the memory cell based on channel information of the memory cell according to the region.

15. The method of claim 14, further comprising:
determining the plurality of soft decision reference voltages based on the channel information of the memory cell.

16. The method of claim 15, further comprising:
allocating a soft decision value based on the channel information of the memory cell, according to the region,
wherein the detecting detects data stored in the memory cell based on the allocated soft decision value.

17. The method of claim 15, wherein the determining determines the soft decision reference voltage so that intervals between the plurality of soft decision reference voltages are irregular.

18. The method of claim 15, wherein,
the channel information includes information about an error rate according to the threshold voltage, and
the determining determines the intervals between the plurality of soft decision reference voltages based on the error rate.

19. The method of claim 18, wherein the determining determines the plurality of soft decision reference voltages so that the intervals between the plurality of soft decision reference voltages are close with respect to a region with a larger error rate from among a range of the threshold voltages.

20. The method of claim 14, further comprising:
allocating a soft decision value based on channel information of the memory cell according to the region,
wherein the detecting detects data stored in the memory cell based on the allocated soft decision value.

21. The method of claim 20, wherein,
the channel information includes information about an error rate according to the threshold voltage, and
the allocating allocates the soft decision value according to the information about the error rate.

22. The method of claim 20, wherein the allocating allocates a small soft decision value to a region with a large error rate, and allocates a large soft decision value to a region with a small error rate, from among a range of the threshold voltages.

23. The method of claim 14, further comprising:
storing pilot data in a predetermined bit pattern in the memory cell; and
estimating channel information of the memory cell,
wherein the detecting detects the stored pilot data, and the estimating estimates the channel information of the memory cell based on the detected pilot data.
